(19) United States
(12) Patent Application Publication
(10) Pub. No.: US 2008/0254662 A1
(43) Pub. Date: Oct. 16, 2008

(54) Electrical Connector for Flat Flexible Cable

(76) Inventor: Masahiro Koga, Kanagawa (JP)

Correspondence Address: HARRINGTON & SMITH, PC, 4 RESEARCH DRIVE, SHELTON, CT, 06484-6212, US

(21) Appl. No.: 11/666,593

(22) PCT Filed: Nov. 1, 2005
(86) PCT No.: PCT/JP2005/020100

§ 371 Date: Jan. 25, 2008

(30) Foreign Application Priority Data
Nov. 2, 2004 (JP) 2004-318725

(51) Int. Cl. H01R 12/24; H01R 13/62

(52) U.S. Cl. 439/260; 439/495

(57) ABSTRACT

An electric connector, wherein when a flat flexible cable is inserted thereinto with an actuator kept open, the actuator is automatically closed. The opening/closing type actuator includes an actuator operation part rotatable together with an actuator body part and actuator projected piece parts projected at both end parts of the actuator operation part. The contact beam of a contact piece is formed to have a deformability capable of producing a deformation thereon by a pressing force acting thereon from the actuator operation part when it is brought into contact with the actuator operation part in opening the actuator and a recovering force acting thereon so as to return the actuator to a closed state. When the front part of the flat flexible cable (C) is brought into contact with the projected piece part of the actuator with the actuator kept open and the flat flexible cable (C) is pushed in, the actuator operation part is rotated to close the actuator.

### TECHNICAL FIELD

The present invention relates to an electrical cable for connecting a flat flexible cable.

### BACKGROUND ART

Conventionally, the electrical connectors used for connecting flat flexible cables comprise a plurality of contact pieces arranged with a predetermined spacing inside an electrical connector, and an actuator for receiving and securing the flat flexible cable so that the contact pieces connect with contacts on the flat flexible cable.

### Patent Document 1: JP 2002-134194 A

### DISCLOSURE OF THE INVENTION

### Problems to be Solved by the Invention

However, in order to connect a flat flexible cable to an electrical connector,,it is necessary to perform three manual steps of opening the actuator, inserting the flat flexible cable into the electrical connector, and closing the actuator.

The present invention has the purpose of offering an electrical connector for a flat flexible cable in which the actuator automatically closes when the flat flexible cable is inserted with the actuator in an open state.

### Means for Solving the Problem

(1) In order to achieve the above purpose, the electrical connector for a flat flexible cable according to the present invention is an electrical connector for a flat flexible cable comprising an opening/closing actuator, a plurality of contact pieces contacting the flat flexible cable, and a casing holding the contact pieces; wherein the actuator comprises an actuator body portion, a rotatable actuator action portion extending in a direction perpendicular to the direction of insertion of the flat flexible cable, and an actuator projecting pieces projecting from end portions of the actuator action portion; the contact pieces comprise a contact beam having a contact contacting a first surface of the flat flexible cable, and a fixed base beam supporting a second surface of the flat flexible cable, the contact beam and fixed base beam being connected together at one end; the contact beam buts against the actuator action portion when the actuator is opened, has a deforming ability wherein deformation occurs due to a force exerted from the actuator action portion, and has a return force that acts to return the actuator to a closed state; and by bringing a front surface portion of the flat flexible cable and the actuator projecting pieces into abutment with the actuator in an open state and pushing in the flat flexible cable, the actuator action portion can be rotated to close the actuator.
(2) Additionally, the actuator action portion preferably has a cross sectional shape in the insertion direction of the flat flexible cable such that the cross-sectional length in a long-axis direction is greater than a cross-sectional length in a short-axis direction, and the contact beam is pushed upward by rotation of the actuator action portion when the actuator is opened.
(3) The electrical connector for a flat flexible cable preferably comprises reinforcing resilient portions comprising a reinforcing base portion and a top reinforcing beam portion and a lower reinforcing beam portion formed unitarily with the reinforcing base portion at both end portions of the actuator action portion; and the top reinforcing beam portion has a deforming ability wherein deformation occurs due to a force exerted from the actuator action portion when the actuator is opened, and has a return force for returning to an original position when the actuator is returned to a closed state.
(4) The contact piece preferably further comprises a top beam.
(5) The flat flexible cable preferably has cutaway portions formed at positions contacting the actuator projecting pieces.

### EFFECTS OF THE INVENTION

(1) In the invention according to claim 1, the structure is such that when the front surface portion of a flat flexible cable and an actuator projecting pieces are brought into abutment with the actuator in an open state, and the flat flexible cable is pushed in, the actuator action portion rotates to close the actuator, thus enabling the actuator to be automatically closed in conjunction with the manual work of pushing in the flat flexible cable, as well as eliminating the need for the manual work of closing the actuator, thereby improving the work efficiency. Since the flat flexible cable is pushed in with the front surface portion of the flat flexible cable and the actuator projecting pieces in abutment, it is possible to confirm by feeling with the hands that the flat flexible cable has been inserted to a predetermined positioned inside the electrical connector for a flat flexible cable. Furthermore, the structure may be such that when inserting the flat flexible cable, there is zero insertion force until the front surface portion of the flat flexible cable and the actuator projecting pieces come into contact.

(2) In the invention according to claim 2, the actuator action portion is formed with a cross-sectional shape in the insertion direction of the flat flexible cable such that the cross-sectional length in the long-axis direction is greater than the cross-sectional length in the short-axis direction, so when the actuator is in an open state, the upper edge in the long-axis direction of the actuator action portion and the contact beam are in a state of abutment, and a force is exerted to push the contact beam upward.
(3) In the invention according to claim 3, reinforcing resilient portions are provided at both end portions of the actuator action portion, so a return force in the downward direction to rotate the actuator action portion and return the actuator to a closed state acts by cooperation between the return force of the contact piece and the return force of the top reinforcing beam portion of the reinforcing resilient portion, thus enabling the actuator to be reliably closed.
(4) In the invention according to claim 4, the contact pieces further have a top beam, enabling the contact pieces to be reliably inserted and affixed to the casing by affixing the upper side of the top beam to the top plate of the casing.
(5) In the invention according to claim 5, the flat flexible cable has cutaway portions formed at positions contacting the actuator projecting pieces, so the actuator projecting pieces of the actuator action portion can be rotated at the position of the cutaway portions.

Additionally, the front surface portion of the flat flexible cable can be inserted to a predetermined position inside the electrical connector for a flat flexible cable.

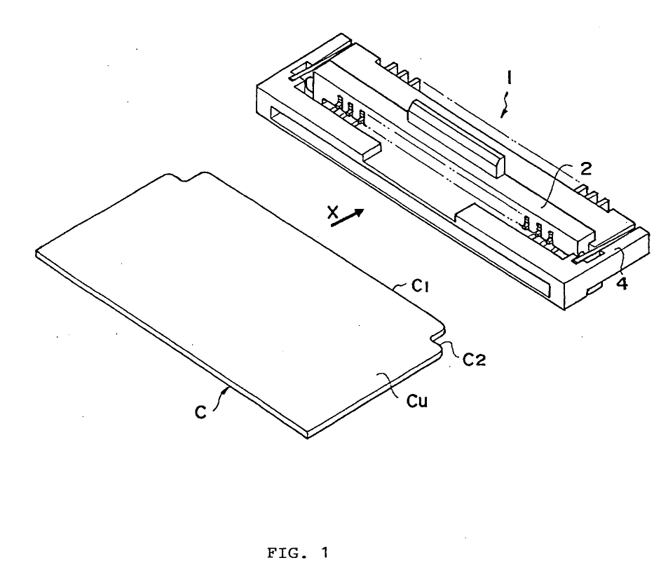

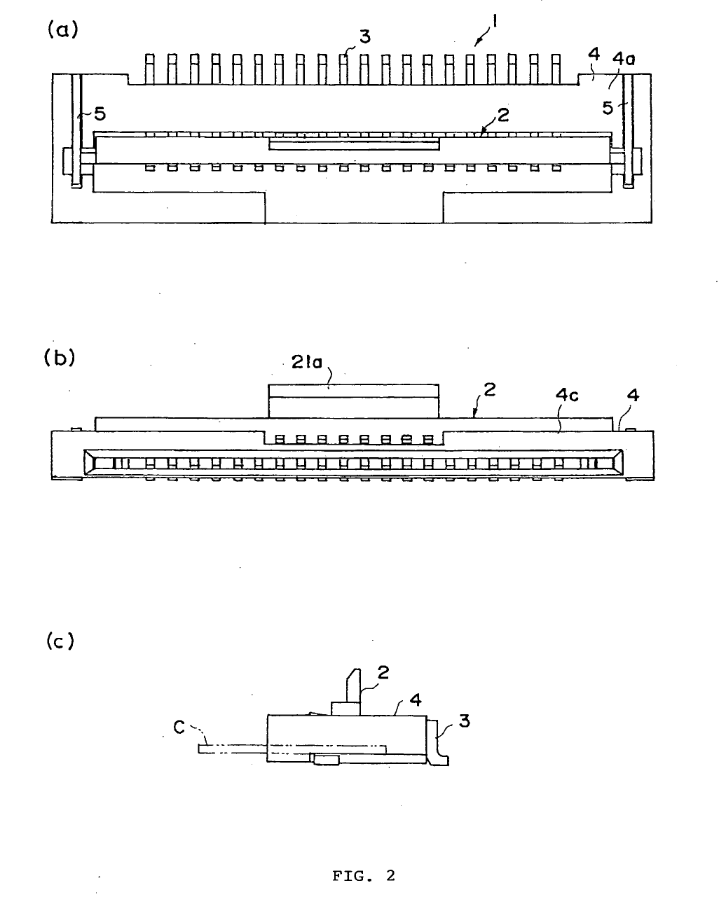

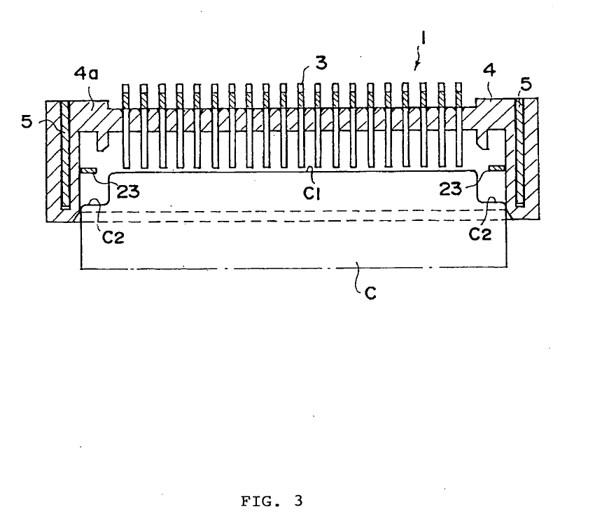

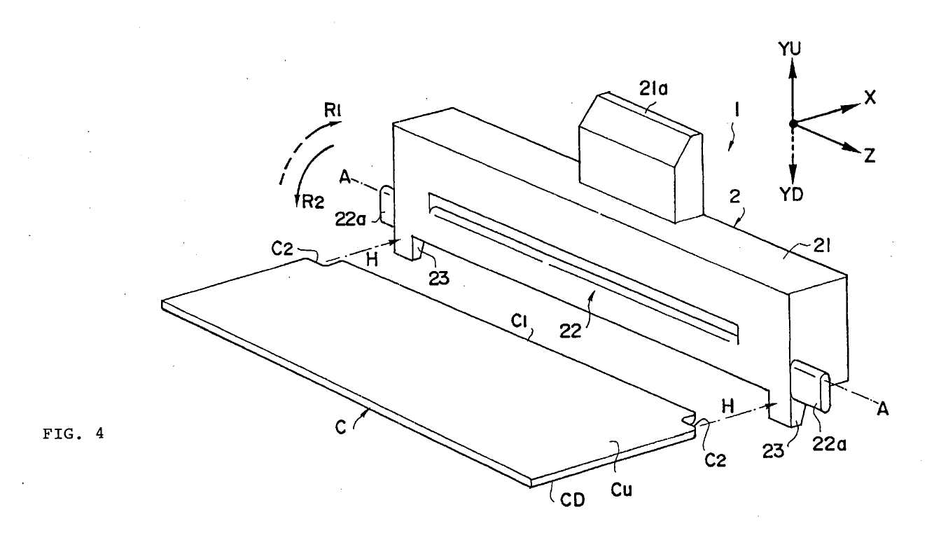

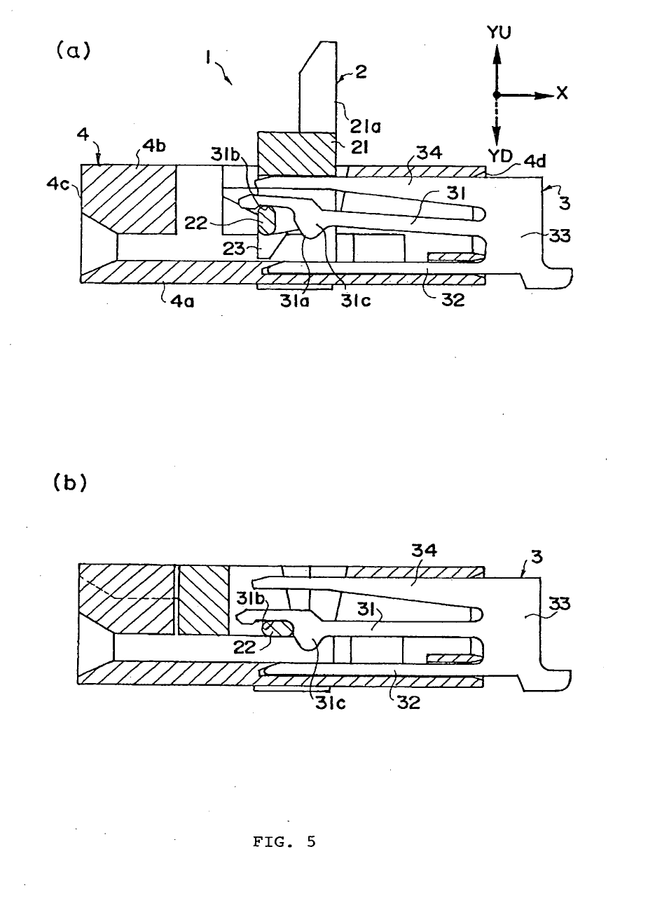

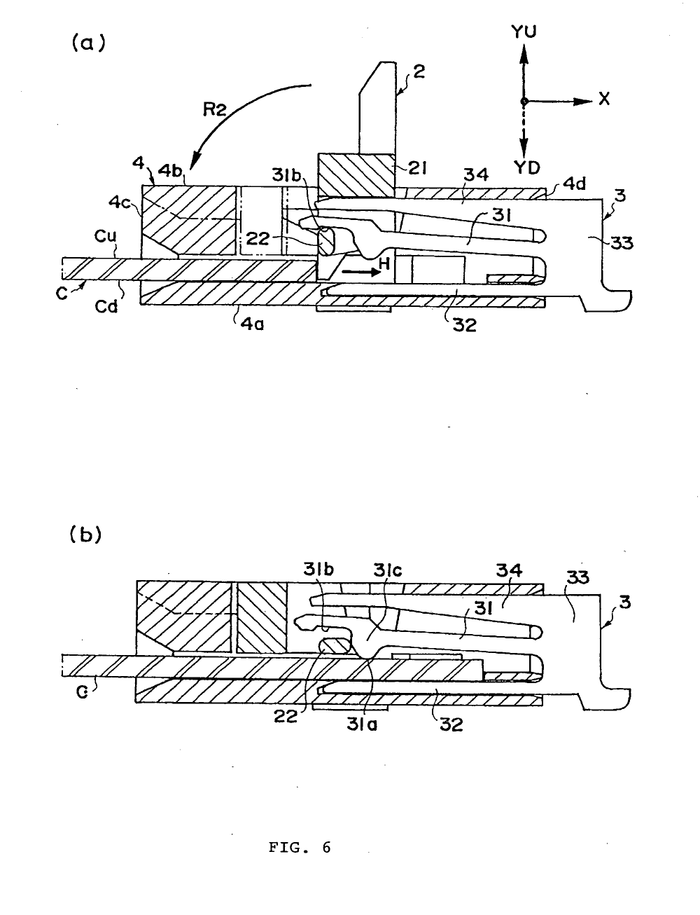

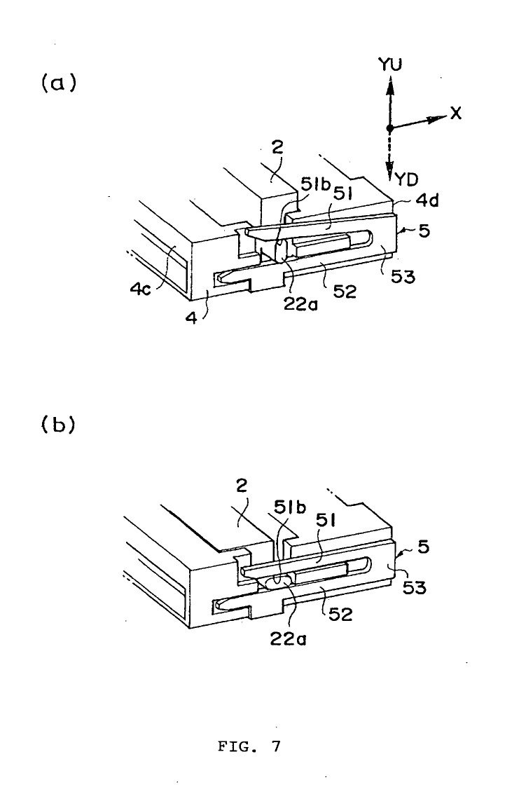

### BRIEF DESCRIPTION OF THE DRAWINGS

[FIG. 1] A perspective view of an electrical connector 1 according to Embodiment 1, seen with the actuator 2 in an open state.

[FIG. 2] A plan view (a), front view (b) and a side view (c) of the electrical connector 1 with the actuator 2 in an open state.

[FIG. 3] A plan view with a flat flexible cable C inserted.

[FIG. 4] A perspective view showing the relationship between the flat flexible cable C and the actuator 2 in the electrical connector 1 of FIG. 1.

[FIG. 5] Side views of an electrical connector 1 with the actuator 2 in an open state (a) and in a closed state (b) (flat flexible cable C not inserted).

[FIG. 6] Side views of an electrical connector 1 with the actuator 2 in an open state (a) and in a closed state (b) (flat flexible cable C inserted).

[FIG. 7] Perspective views (a) and (b) of an electrical connector 1 provided with a reinforcing resilient portion 5.

### EXPLANATION OF REFERENCE NUMBERS

1 . . . electrical connector
2 . . . actuator
3 . . . contact piece
4 . . . casing
5 . . . reinforcing resilient portion
21 . . . actuator body portion
21a . . . actuator grip portion
22 . . . actuator action portion
22a . . . end portions of actuator action portion
23 . . . actuator projecting piece
31 . . . contact beam
31a . . . contact beam contact
31b . . . contact beam abutment portion
31c . . . contact beam projecting portion
32 . . . fixed bottom beam
33 . . . contact piece base portion
34 . . . top beam
51 . . . top reinforcing beam portion
51b . . . top reinforcing beam abutment portion
52 . . . bottom reinforcing beam portion
53 . . . reinforcing base portion
C . . . flat flexible cable
C1 . . . front face of flat flexible cable
C2 . . . cutaway portion of flat flexible portion

### Best Modes for Carrying Out the Invention

Examples of preferred embodiments of the present invention shall be described with reference to the drawings. In the drawings, the same reference numbers are used for the same elements, and their explanations may be omitted.

### Embodiment 1

FIG. 1 is a perspective view showing an electrical connector 1 for a flat flexible cable (hereinafter referred to as “electrical connector 1”) with the actuator 2 in an open state. FIG. 2 shows a plan view, front view and side view of the electrical connector 1 with the actuator 2 in an open state. FIG. 3 is a plan view with a flat flexible cable C inserted.

First, the flat flexible cable C shall be explained. While such cables include many types such as flexible printed cable (FPC) and flexible flat cable (FFC), they shall be referred to collectively in the present specification as flat flexible cable C below.

The flat flexible cable C is in the form of a thin sheet of roughly rectangular shape in plan view, with cutaway portions C2 at positions contacting actuator projecting pieces 23, 23 to be described below at both ends of the front surface portion C1 of the flat flexible cable C. The flat flexible cable C has a “top contact” structure wherein a plurality of contacts are arranged on a first surface (top surface) CU (contacts not shown in FIG. 1). When the flat flexible cable C is inserted into the electrical connector 1, the contacts of the flat flexible cable C come into contact with the contact pieces 3 to complete a connection.

The electrical connector 1 comprises an opening/closing actuator 2, a plurality of contact pieces 3 contacting the flat flexible cable C, a casing 4 holding the contact pieces 3 and a reinforcing resilient portion 5.

FIG. 4 is a perspective view focusing on only the actuator 2 and flat flexible cable C of the electrical connector 1 shown in FIG. 1, omitting the contact pieces 3, the casing 4 and the reinforcing resilient portions 5.

In the electrical connector 1 shown in FIG. 4, X denotes the direction of insertion of the flat flexible cable C, Z denotes the direction perpendicular to the direction of insertion of the flat flexible cable C (hereinafter referred to as “perpendicular direction Z”), YU denotes the upward direction and YD denotes the downward direction. Here, X and Z lie on a single plane in the direction of insertion of the flat flexible cable C. YU and YD lie on a plane in an extraplanar direction perpendicular to the plane of the direction of insertion, YU being the direction toward the top plate 4b of the casing 4 and YD being the direction toward the bottom plate 4a of the casing 4. The upward direction YU and downward direction YD are terms used for convenience of explanation, and are not meant to refer strictly to the up-down direction after installation of the electrical connector 1. R1 denotes a rotation direction (clockwise in FIG. 4) in which the actuator 2 opens, and R2 denotes a rotation direction (counterclockwise in FIG. 4) in which the actuator 2 closes.

As shown in FIG. 4, the actuator 2 comprises an actuator body portion 21, an actuator action portion 22 that extends in and is rotatable about the perpendicular direction Z and actuator projecting pieces 23, 23 projecting from the ends of the actuator action portion 22.

The actuator body portion 21 is a lid that can be opened or closed with respect to the top plate 4b of the casing 4, having at its tip an actuator grip portion 21a for gripping with the hand.

Since the actuator body portion 21 and the actuator action portion 22 are formed with an integrated structure, the actuator body portion 21 and the actuator action portion 22 rotate about the perpendicular direction Z as a single body.

The actuator action portion 22 is a rod-shaped body that supports the actuator body portion 21 so as to be rotatable about the perpendicular axis Z. The actuator action portion 22 has a straight line in the perpendicular direction Z passing through an arbitrary point in the cross section of the element as an axis of rotation A (indicated by the single-dotted dashed line in FIG. 4). The end portions 22a, 22a protrude by a certain length from the end surfaces of the actuator body portion 21, these end portions 22a, 22a being elements for restricting the rotation of the actuator 2, and supported in a floating state. For example, the end portions 22a, 22a of the actuator action portion 22 can be supported in a floating state by adding reinforcing resilient portions 5 formed as separate elements.

The central portion of the actuator action portion 22 is separated from the actuator body portion 21 by slits into which the contact pieces 3 are inserted depending on the number (20 in Embodiment 1) of contact pieces. In FIG. 4, the 20 slits are simply represented as a single elongated slit in order to explain the drawing.

The actuator action portion 22 has a cross section roughly in the shape of an ellipse whose cross-sectional length in the long-axis direction is greater than the cross-sectional length in the short-axis direction. Here, the cross-sectional shape of the actuator action portion 22 refers to the cross-sectional shape in the plane perpendicular to the axis of rotation A (perpendicular direction Z).

The cross-sectional shape of the actuator action portion 22 can be made into a shape other than roughly elliptical, as long as the cross-sectional length in the long-axis direction is greater than the cross-sectional length in the short axis direction. The difference between the cross-sectional length in the long-axis direction and the cross-sectional length in the short-axis direction of the actuator action portion 22 is adjusted so as to form a clearance in the up-down direction between the fixed bottom beam 32 and the contact beam projecting portion 31c such that the flat flexible cable C can be inserted with zero insertion force.

The actuator projecting pieces 23, 23 are elements that project from the area of the end portions 22a, 22a of the actuator action portion 22 such as to intersect with the rotational axis A (corresponding to the perpendicular direction Z) of the actuator action portion 22. When a flat flexible cable C is manually inserted with the actuator 2 in an open state (with the actuator 2 rotated in the R1 direction and upright), and the cutaway portion C2 of the front surface C1 of the flat flexible cable C and the actuator projecting pieces 23, 23 are brought into abutment, pushing in the flat flexible cable C causes the actuator action portion 22 to rotate in the direction of rotation R2 to close the actuator 2.

FIG. 5 shows side views of the electrical connector 1 with the actuator 2 in an open state and a closed state without the flat flexible cable C inserted. FIG. 6 shows side views of the electrical connector 1 with the actuator 2 in an open state and a closed state with the flat flexible cable C inserted.

As shown in FIGS. 5 and 6, each contact piece 3 is a flat element comprising a contact piece base portion 33, and a fixed bottom beam 32, a contact beam 31 and a top beam 34 that extend from the contact piece base portion 33.

While a plurality (20 in Embodiment 1) of contact pieces 3 are arrayed at a predetermined spacing along the perpendicular direction Z of the casing 4, the contact pieces 3 are inserted from the rear surface portion 4d of the casing and affixed to the casing.

The contact beam 31 is an element that extends in the form of a cantilever from the contact piece base portion 33, for which the tip portion (front surface 4c side of the casing) is free and the base portion (rear surface 4d side of the casing) is fixed. The contact beam 31 forms a contact beam abutment portion 31b that buts against the actuator action portion 22 on the bottom side near the free end, and has a contact beam projecting portion 31c that projects downward at a position midway between the free end and the base portion, the lowermost portion of the contact beam projecting portion 31c forming a contact 31a connecting to the first surface CU of the flat flexible cable C.

Since the contact beam 31 is an element that extends in the form of a cantilever with a tip that is free and a base that is fixed, and has a contact beam abutment portion 31b for contacting the actuator action portion 22 formed at the bottom side in the vicinity of the free end, it has a deforming ability wherein deformation (elastic deformation) occurs due to a force in the upward direction YU exerted from the actuator action portion 22 onto the contact beam abutment portion 31b when the actuator 2 is opened and the actuator action portion 22 is rotated. Furthermore, the contact beam 31 is structured so as to have a return force (elastic return force) in the downward direction YD whereby the contact beam 31 returns to the original position in the up-down direction when the force in the upward direction YU exerted on the contact beam abutment portion 31b is released, thus automatically closing the actuator 2.

By adjusting the difference between the cross-sectional length in the long axis direction and the cross-sectional length in the short axis direction of the actuator action portion 22, the value of the return force on the contact beam 31 in the downward direction YD can be adjusted.

Since the actuator action portion 22 is formed with a cross section roughly in the shape of an ellipse whose cross-sectional length in the long axis direction is longer than the cross-sectional length in the short-axis direction, when the actuator 2 is in an open state, the upper edge in the long axis direction of the actuator action portion 22 and the contact beam abutment portion 31b of the contact beam 31 but against each other, so that a force in the upward direction YU is exerted from the actuator action portion 22 onto the contact beam 31 (see FIGS. 5(a) and 6(a)). On the other hand, when the actuator 2 is closed without the flat flexible cable C inserted, the upper edge portion in the short-axis direction of the actuator action portion 22 and the contact beam abutment portion 31b of the contact beam 31 come into contact, but no force in the upward direction YU is exerted from the actuator action portion 22 onto the contact beam 31 (see FIG. 5(b)). In the state wherein the actuator 2 is closed after insertion of a flat flexible cable C, the upper edge portion in the short axis direction of the actuator action portion 22 and the contact beam abutment portion 31b of the contact beam 31 are separated, so the force in the upward direction YU from the actuator action portion 22 to the contact beam 31 is relieved, but the contact 31a of the contact beam projecting portion 31c is in contact with the first surface CU of the flat flexible cable C, so the contact beam 31 presses on the flat flexible cable C in a downward direction (see FIG. 6(b)).

The top beam 34 is an element (see FIGS. 5 and 6) that extends in the form of a cantilever from the contact piece base portion 33, for which the tip portion (front surface 4c side of the casing) is free and the base portion (rear surface 4d side of the casing) is fixed.

The top beam 34 is an element that is positioned so as to suppress deformation of the contact beam 31 in the upward direction YU in the vicinity of the free end when the actuator 2 is open.

The top beam 34 has the ability to deform by being pushed downward when the actuator 2 is opened and the actuator body portion 21 buts against the top beam 34 in the vicinity of the free end, and due to this deforming ability, enables a force F2 in the upward direction YU (other direction), opposite the force F1 in the downward direction YD (one direction) on the contact beam 31, to be exerted on the actuator body portion 21.

The fixed base beam 32 is an element that extends straight from the contact piece base portion 33, the bottom side of which is affixed to the bottom plate 4a of the casing.

Since the return force of the contact beam 31 exerts a force in the downward direction YD, the contact 31a of the contact beam 31 connects with the first surface CU of the flat flexible cable C, and the top side of the fixed base beam 32 connects with the second surface (bottom surface) Cd of the flat flexible cable C, so that the flat flexible cable C is pinched from above and below by the contact beam 31 and the fixed base beam 32 for connection to the contact piece 3 (see FIG. 6(b)).

As shown in FIG. 7, the reinforcing resilient portion 5 is a flat metal element that is provided at both end portions of the actuator 2, comprising a reinforcing base portion 53, and a top reinforcing beam portion 51 and bottom reinforcing beam portion 52 formed integrally with the reinforcing base portion 53.

The bottom reinforcing beam portion 52 is a straight element that extends from the reinforcing base portion 53, the bottom side being affixed to the bottom plate 4a of the casing.

The top reinforcing beam portion 51 is an element that extends in the form of a cantilever from the reinforcing base portion 53 with a tip portion (front surface 4c side of the casing) that is free and a base portion (rear surface 4d side of the casing) that is fixed, with a top reinforcing beam abutment portion 51b formed at the bottom side in the vicinity of the free end.

The top reinforcing beam portion 51 has a deforming ability wherein deformation (elastic deformation) occurs due to a force in the upward direction YU exerted at the point of contact between the top reinforcing beam abutment portion 51b of the top reinforcing beam portion 51 and the top edge of the actuator action portion 22 when the actuator 2 is opened and the actuator action portion 22 rotated. Furthermore, the top reinforcing beam portion 51 has a structure such that when the flat flexible cable C is inserted with the actuator 2 in an open state and the actuator action portion 22 is rotated in the direction of rotation R2, the force in the upward direction YU exerted by the actuator action portion 22 on the top reinforcing beam portion 51 is released, so that the top reinforcing beam portion 51 has a return force (elastic return force) in the downward direction YD to return to the original position in the up-down direction.

Next, the mechanism for automatically closing the actuator 2 by the manual procedure of inserting the flat flexible cable C will be explained.

As shown in FIG. 5(a), as a first step, the actuator 2 is opened (state with actuator 2 rotated in the direction of rotation R1 and upright) without inserting the flat flexible cable C. The actuator action portion 22 is formed with a cross-sectional shape that is roughly elliptical with the cross-section length in the long-axis direction greater than the cross-sectional length in the short-axis direction. As a result, when the actuator 2 is opened and the top edge in the long-axis direction of the actuator action portion 22 and the contact beam abutment portion 31b of the contact beam 31 are brought into abutment, the actuator action portion 22 exerts a force (load) in the upward direction YU on the contact beam 31, so that the free end of the contact beam 31 is deformed in the upward direction YU. At this time, this deformation generates a return force in the downward direction YD to return to the original position in the contact beam 31, but the line of action of the load of the return force in the downward direction YD is toward the axis of rotation A of the actuator action portion 22, so the return force in the downward direction YD of the contact beam 31 does not generate a rotational moment (torque) on the actuator action portion 22. Therefore, the return force in the downward direction YD of the contact beam 31 and the force in the upward direction YU of the actuator action portion 22 maintain a “state of equilibrium of forces in the up-down direction” in which there are equal forces of the same value in opposite directions on a straight line in the up-down direction.

Next, as shown in FIG. 6(a), as a second step, the flat flexible cable C is pushed in 11 the direction of insertion X with the actuator 2 in an open state, thereby bringing the cutaway portions C2 provided on the front surface C1 of the flat flexible cable C and the actuator projecting-pieces 23, 23 provided on the end portions 22a, 22a of the actuator action portion 22 into abutment (see FIG. 6(a)). When the flat flexible cable C is pushed further, a force H (hereinafter referred to as “insertion force H”) in the insertion direction X is exerted from the cutaway portions C2 of the flat flexible cable C onto the actuator projecting pieces 23, 23. The insertion force H exerted on the actuator projecting pieces 23, 23 acts as a rotational moment (torque) in the direction of rotation R2 with the actuator action portion 22 as the axis of rotation A, thereby disrupting the “state of equilibrium of forces in the up-down direction” between the contact beam 31 and the actuator action portion 22, and the actuator action portion 22 begins to rotate in the direction of rotation R2. Then, the return force in the downward direction YD that was being exerted on the contact beam 31 also begins to act as a rotational moment (torque) in the direction of rotation R2 with the actuator action portion 22 as the axis of rotation A. As a result, the rotational moment due to the insertion force H of the actuator projecting pieces 23, 23 and the rotational moment due to the return force in the downward direction YD of the contact beam 31 cooperate to rotate the actuator action portion 22 in the direction of rotation R2 to automatically close the actuator 2 (see FIG. 6(b)). That is, the present invention has a “one-touch closing structure” wherein the actuator automatically closes as a consequence of the manual work of pushing in the flat flexible cable C with the actuator 2 in an open state, thus eliminating the bother of having to close the actuator 2 manually.

Furthermore, as shown in FIG. 7, in Embodiment 1, reinforcing resilient portions 5 are provided at the ends of the actuator 2.

Like the contact beam 31, the reinforcing resilient portions 5 are deformed by forces in the upward direction YU generated at the points of contact between the top reinforcing beam abutment portion 51b and the top edge of the actuator action portion 22, whereby the top reinforcing beam portion 51 has a return force in the downward direction YD to return to the original position in the up-down direction.

Therefore, by providing the reinforcing resilient portion 5, the return force in the downward direction YD is the combination of the return force of the contact beam 31 of the contact piece 30 and the return force of the top reinforcing beam portion 51 of the reinforcing resilient portion 5, as a result of which the rotational moment for rotating the actuator action portion 22 in the direction of rotation R2 is further increased.

While an embodiment of the present invention has been explained above by giving an example, the present invention is not limited to the above example, and can include additions or modifications within the range of the gist of the present invention.

1. An electrical connector for a flat flexible cable comprising an opening/closing actuator, a plurality of contact pieces contacting the flat flexible cable, and a casing holding the contact pieces; wherein
the actuator comprises an actuator body portion, a rotatable actuator action portion extending in a direction perpendicular to the direction of insertion of the flat flexible cable, and an actuator projecting pieces projecting from end portions of the actuator action portion;
the contact pieces comprise a contact beam having a contact contacting a first surface of the flat flexible cable, and a fixed base beam supporting a second surface of the flat flexible cable, the contact beam and fixed base beam being connected together at one end;
the contact beam buts against the actuator action portion when the actuator is opened, has a deforming ability wherein deformation occurs due to a force exerted from the actuator action portion, and has a return force that acts to return the actuator to a closed state; and
by bringing a front surface portion of the flat flexible cable and the actuator projecting pieces into abutment with the actuator in an open state and pushing in the flat flexible cable, the actuator action portion can be rotated to close the actuator.

2. An electrical connector for a flat flexible cable in accordance with claim 1, wherein said actuator action portion has a cross sectional shape in the insertion direction of the flat flexible cable such that the cross-sectional length in a long-axis direction is greater than a cross-sectional length in a short-axis direction, and the contact beam is pushed upward by rotation of the actuator action portion when the actuator is opened.

3. An electrical connector for a flat flexible cable in accordance with claim 1, wherein said electrical connector for a flat flexible cable comprises reinforcing resilient portions comprising a reinforcing base portion and a top reinforcing beam portion and a bottom reinforcing beam portion formed unitarily with the reinforcing base portion at both end portions of the actuator action portion; and
the top reinforcing beam portion has a deforming ability wherein deformation occurs due to a force exerted from the actuator action portion when the actuator is opened, and has a return force for returning to an original position when the actuator is returned to a closed state.

4. An electrical contact for a flat flexible cable in accordance with claims 1, wherein said contact piece further comprises a top beam.

5. An electrical contact for a flat flexible cable in accordance with claim 1, wherein said flat flexible cable has cutaway portions formed at positions contacting the actuator projecting pieces.
